(19) United States
(12) Patent Application Publication
(10) Pub. No.: US 2012/0121397 A1
(43) Pub. Date: May 17, 2012

(54) TURBINE ROTOR FOR A TURBOCHARGER, TURBOCHARGER AND METHOD FOR PRODUCING A TURBINE ROTOR

(75) Inventors: Ulrike Albuzat, Mannheim (DE); Bruno Ferling, Beindersheim (DE); Guenter Muench, Carlsberg (DE)

(73) Assignee: CONTINENTAL AUTOMOTIVE GMBH, HANOVER (DE)

(21) Appl. No.: 13/380,730

(22) PCT Filed: Jun. 7, 2010
(86) PCT No.: PCT/EP10/57906

§ 371 Date: Jan. 24, 2012

(30) Foreign Application Priority Data
Jun. 23, 2009 (DE) 10 2009 030 042.2

(51) Int. Cl. F04D 29/40; B23K 20/12; F01D 5/14

(52) U.S. Cl. 415/182.1; 416/223 A; 416/241 R; 228/114.5

(57) ABSTRACT

A turbine rotor for a turbocharger, in particular for a motor vehicle, has a turbine wheel which is formed in one piece and which has a turbine blade arrangement and a solid turbine wheel shoulder with a first end surface without cavities or depressions. A rotor shaft is formed in one piece and has a second end surface with a depression arranged coaxially with respect to the rotational axis. The first end surface of the turbine wheel shoulder is connected to a second end surface of the rotor shaft in a cohesive fashion by way of a friction weld. There is also provided a turbocharger and a method for producing a corresponding turbine rotor.

The present invention relates to a turbine rotor for a turbocharger. The present invention relates, furthermore, to a turbocharger and to a method for producing a turbine rotor.

DE 10 2007 018 618 A1 describes the generally known set-up of a turbocharger for increasing the power of an internal combustion engine of a motor vehicle, said turbocharger being composed essentially of a radial turbine with a turbine wheel, which is driven by the exhaust gas stream from the internal combustion engine, and of a radial compressor arranged in the intake tract of the internal combustion engine and having a compressor wheel which is connected to the turbine wheel fixedly in terms of rotation by means of a rotor shaft. The turbine wheel is connected to the rotor shaft mostly in a materially integral way and to the compressor wheel mostly positively. The rotor shaft/turbine wheel subassembly is designated below as the turbine rotor of the exhaust gas turbocharger.

On account of mostly very different requirements to be met, on the one hand, by turbine wheels, which, because of the hot exhaust gases of the internal combustion engine, are partly exposed to very high temperatures and, because of the very high rotational speeds of up to 300 000 rev/min occurring during the operation of the turbocharger, to high centrifugal forces, and, on the other hand, by rotor shafts which, as part of the mounting system of the turbocharger, have to absorb a high alternate bending load, the respective materials from which these components are manufactured are typically very different.

On account of the high mechanical loads on the turbine rotor which occur when a turbocharger is in operation, welding as a connecting technique for connecting the turbine wheel and rotor shaft has become the method of choice in the case of modern turbochargers in the motor vehicle sector. In light of the different materials just mentioned for the turbine wheel and the rotor shaft, the welding method primarily employed for connecting these components is the rotary friction welding method.

Both DE 697 18 713 T2 and WO 2008/046556 A2 and EP 1 002 935 A1 describe methods for connecting a rotor shaft to a turbine wheel by rotary friction welding. In rotary friction welding, either the rotor shaft or the turbine wheel is brought to a specific rotational speed and then pressed against the stationary component. This gives rise to frictional heat and the materials are welded to one another. By the rotating component being pressed against the stationary component, however, material of the softer welding partner in the pasty state is also pressed away to the side. This does not present any problem with regard to the outer face of the rotor shaft, since sufficient space is available for the material which has been pressed away. This material pressed outward can easily be removed by means of a cutting method in a work step following the rotary friction welding operation.

However, a cavity has to be made available in the direction of the axis of rotation of the rotor shaft for the material which flows away, so that a build-up of material does not occur and so that the welded joint does not have insufficient strength.

As disclosed, for example in JP 580 50 189 A, this cavity is provided in both welding partners, as a result of which, with regard to the turbine wheel, the strength of the turbine wheel back may be reduced on account of the clearance which is provided. This may lead to material fracture in the turbine wheel and even to the destruction of the turbocharger.

Furthermore, the turbine wheel has to be cast onto the turbine wheel hub from the side of the compressor blading, since the cavity can then be incorporated by casting, and therefore there is no need for the cavity to be made by cutting in a time-consuming and cost-intensive way. This results, however, in a flow-impeding form of the turbine wheel hub, since the hub has to be given a large cross section so that the casting material does not solidify prematurely.

The positioning for casting the turbine wheel on the turbine wheel hub very often leads, without further measures, to a markedly poorer formation of the material structure in the region of the turbine wheel hub and the turbine wheel blading.

It is, of course, expedient to avoid the disadvantages just mentioned, which result overall in a turbine rotor which is not optimal.

Against this background, the object on which the present invention is based is to propose an improved turbine rotor.

This object is achieved, according to the invention, by means of a turbine rotor having the features of patent claim 1 and/or by means of a turbocharger having the features of patent claim 7 and/or by means of a method having the features of patent claim 8.

Accordingly, what is provided is:

A turbine rotor for a turbocharger, in particular for a motor vehicle, with a rotor shaft which is formed in one piece, and with a turbine wheel which is formed in one piece and has turbine blading and a solidly formed turbine wheel shoulder, the turbine blading and the turbine wheel shoulder being arranged on opposite end faces of the turbine wheel, and a first end face of the turbine wheel shoulder being connected to a second end face of the rotor shaft in a materially integral way by means of rotary friction welding. In this case, the solid turbine wheel shoulder is formed without cavities or depressions, and the second end face of the rotor shaft has a depression which is arranged coaxially to the axis of rotation and which serves for the reception of plasticized material of the turbine wheel shoulder and/or of the rotor shaft.

A turbocharger for a motor vehicle, with a turbine rotor according to the invention, the turbocharger having a turbine casing, the turbine wheel which is arranged in the turbine casing, a compressor casing, a compressor wheel arranged in the compressor casing, and the rotor shaft which connects the turbine wheel fixedly in terms of rotation to the compressor wheel. It is thereby possible to use the turbine rotor according to the invention, having the advantages described above, in a turbocharger, preferably in a motor vehicle.

A method for producing a turbine rotor according to the invention, having the following steps taking place in succession: coaxial clamping of the rotor shaft and turbine wheel into a rotary friction welding device; rotation of the rotor shaft; pressing of the second end face of the rotor shaft onto the first end face of the turbine wheel shoulder; and rotary friction welding to one another of the rotor shaft and turbine wheel shoulder pressed with their end faces one onto the other.

The rotor shaft and turbine wheel in each case form a one-part and preferably even one-piece component. The turbine wheel has turbine blading and a solidly formed turbine wheel shoulder. A solid turbine wheel shoulder is understood below to mean that the turbine wheel shoulder is formed largely without cavities or depressions and therefore as dimensionally stable an element as possible. The turbine blading and the turbine wheel shoulder are arranged on opposite end faces of the turbine wheel. A first end face of the turbine wheel shoulder is connected to a second end face of the rotor shaft in a materially integral way. According to the invention, the materially integral connection is made by rotary friction welding. In this case, the rotor shaft is set in rotation and is pressed with a defined force coaxially onto the turbine wheel shoulder of the stationary turbine wheel.

The idea on which the preset invention is based is primarily to form the turbine wheel shoulder solidly, without cavities or depressions, and to provide a depression for the reception of plasticized material of the turbine wheel shoulder and/or of the rotor shaft solely in the end face of the rotor shaft. This reliably prevents the situation where a build-up of plasticized material occurs, with the result that the reliability of the materially integral connection between the turbine wheel and rotor shaft would be reduced.

It is thereby possible to make available a materially integral connection of high reliability between the rotor shaft and the turbine wheel.

Furthermore, this is especially cost-effective in production terms. In contrast to known solutions, there is therefore no need to provide, in the turbine wheel shoulder, a depression which has to be made by means of a casting method or cutting method. According to the invention, therefore, the situation can also be effectively prevented where a material fracture occurs in the turbine wheel on account of the notch effect of a depression in the turbine wheel shoulder. At the same time, a reliable materially integral connection between the turbine wheel and rotor shaft is ensured.

Advantageous refinements and developments of the present invention may be gathered from the further subclaims and from the description in conjunction with the figures of the drawing.

In a typical refinement of the present invention, the turbine wheel shoulder is formed as a projection which rises out of one of the end faces of the turbine wheel and which is rotationally symmetrical with respect to an axis of rotation of the turbine wheel. It is thereby possible to machine the turbine wheel shoulder quickly and cost-effectively by means of a cutting method, such as, for example, cylindrical grinding or lathe turning. The production costs of the turbine rotor according to the invention are thereby reduced.

In a preferred refinement of the present invention, the first end face which is provided on the turbine wheel shoulder is welded by rotary friction to the second end face which is provided on the rotor shaft, the rotor shaft being oriented coaxially to the turbine wheel shoulder. As a result, different materials of the rotor shaft and of the turbine wheel shoulder can be connected quickly and reliably in a materially integral way. Consequently, the production costs of the turbine rotor are reduced and the reliability of the materially integral connection between the turbine wheel and the rotor shaft is increased significantly.

In a preferred refinement of the present invention, the depression is arranged coaxially to an axis of rotation of the rotor shaft, with the result that the depression can be made simply and quickly by lathe turning. The production costs and production time of the turbine rotor according to the invention are thereby reduced.

In a likewise preferred refinement of the present invention, the rotor shaft is manufactured from an alloyed high-grade steel, in particular from an alloyed high-grade steel with chromium, molybdenum and vanadium as the main alloying components. It is thereby possible for the rotor shaft, as part of the mounting system of a turbocharger, to absorb a high alternate bending load. The lifetime of the turbine rotor and therefore the lifetime of the turbocharger are thereby increased.

In a further preferred refinement, the turbine wheel is manufactured from a nickel-based alloy, in particular from a nickel-based alloy for high-temperature applications. As a result, the turbine wheel withstands very high exhaust gas temperatures and the high centrifugal forces occurring when a turbocharger is in operation. The lifetime and reliability of the turbine rotor according to the invention are thereby increased advantageously.

In a likewise preferred refinement, the turbine wheel is a turbine wheel which is produced as a metal casting and has a cast-on part which is arranged on the first end face. When a turbine wheel is being cast on via the turbine wheel shoulder, an improved material structure is obtained in the region of the turbine blading and turbine hub and the turbine hub can have a more streamlined configuration. As a result, on the one hand, the probability of failure of the turbine blading on account of a poor formation of the material structure is reduced. On the other hand, due to a more streamlined turbine hub, the efficiency of a turbocharger having a turbine rotor according to the invention is improved.

In a preferred refinement of the method of the present invention, an annular weld bead, which is generated during rotary friction welding and is present on a surface area of the rotor shaft and on a surface area of the turbine wheel shoulder, is subsequently removed. It is thereby possible to bring the transition between the rotor shaft and turbine wheel shoulder into the desired form, for example into the form of a bearing seat for mounting the rotor shaft.

The weld bead may in this case be removed by means of a cutting method, in particular by means of a cylindrical grinding method. It is thereby possible, using a corresponding forming wheel, to bring the transition between the rotor shaft and turbine wheel shoulder into the final form quickly and cost-effectively. As a result, the production costs and production time for the turbine rotor according to the invention are reduced.

The abovementioned refinements and developments can be combined with one another, insofar as expedient, in any desired way.

The present invention is explained in more detail below by means of the exemplary embodiments indicated in the diagrammatic figures of the drawing in which:

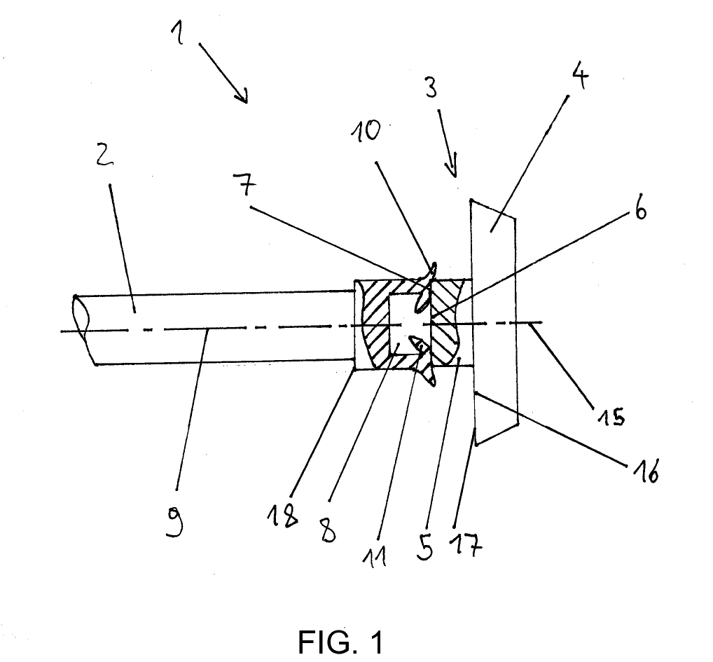

FIG. 1 shows a diagrammatic view of an exemplary embodiment of a turbine rotor according to the invention; and

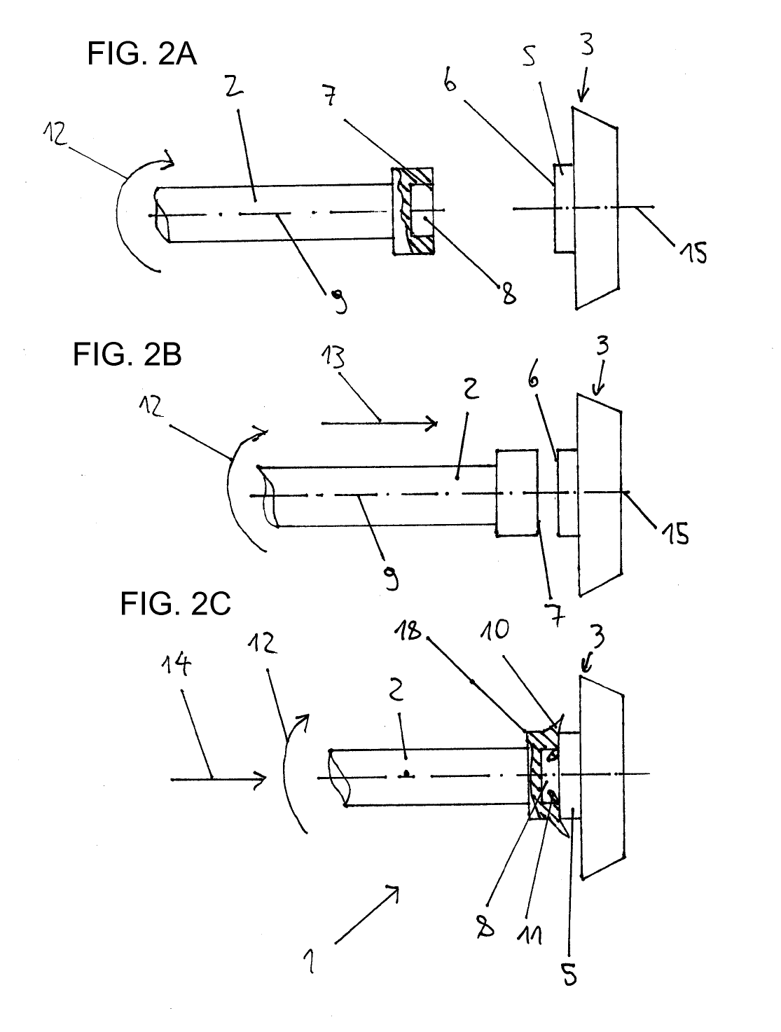

FIG. 2a-c show a diagrammatic view of a method for producing a turbine rotor according to the invention.

Unless stated otherwise, identical components, elements and features have been given the same reference symbols in the figures of the drawing.

FIG. 1 shows a diagrammatic view of an exemplary embodiment of a turbine rotor according to the invention. The turbine rotor according to the invention, designated here by reference symbol 1, has a rotor shaft 2, preferably formed in one piece, with an axis of rotation 9, and a turbine wheel 3, preferably formed in one piece, with an axis of rotation 15. In one piece is to be understood below as meaning that the corresponding components are composed of only one element and are manufactured throughout from the same material. The turbine wheel 3 has a turbine blading 4 and a turbine wheel shoulder 5. The turbine blading 4 and turbine wheel shoulder 5 are arranged on opposite end faces 16, 17 of the turbine wheel 3. The turbine wheel shoulder 5 is formed as a projection which rises out of the end face 17 of the turbine wheel 3 and is rotationally symmetrical with respect to the axis of rotation 15.

Alternatively to this, the turbine wheel shoulder 5 may also have, in a top view of the end face 17, a rectangular or, for example, polygonal or any other desired form. Furthermore, the turbine wheel shoulder 5 has a first end face 6. The turbine wheel shoulder 5 is solidly formed, that is to say it has no cavities or depressions.

The rotor shaft 2 has an axis of rotation 9 and a second end face 7. The second end face 7 has a depression 8 which is preferably arranged coaxially to the axis of rotation 9. The depression 8 is preferably provided as a cylindrical depression 8 formed coaxially to the axis of rotation 9. Alternatively to this, the depression 8 may also be formed, in a top view of the second end face 7, as a rectangular or polygonal depression 8. The rotor shaft 2 preferably has a rotor shaft shoulder 18 in which the depression 8 is provided.

The first end face 6 of the turbine wheel shoulder 5 is connected to the second end face 7 of the rotor shaft 2 in a materially integral way by rotary friction welding, the rotor shaft 2 being oriented coaxially to the turbine wheel shoulder 5. The depression 8 serves for receiving an inner weld bead 11 which is formed during rotary friction welding. An outer weld bead 10 is present on a surface area of the rotor shaft 2 and on a surface area of the turbine wheel shoulder 5.

The turbine wheel 3 is preferably manufactured from a nickel-based alloy, in particular from a nickel-based alloy for high-temperature applications. The turbine wheel 3 is preferably a turbine wheel 3 produced as a metal casting. The blank of the turbine wheel 3 has a cast-on part which is arranged on the first end face 6. It is thereby possible for a turbine wheel hub, not illustrated in FIG. 1, to have a highly streamlined configuration. Furthermore, by the blank of the turbine wheel 3 being cast on via the turbine wheel shoulder 5, especially good structural formation occurs in the region of the turbine blading 4 and of the turbine hub. The rotor shaft 2 is manufactured from an alloyed high-grade steel, in particular from an alloyed high-grade steel with chromium, molybdenum and vanadium as the main alloying components. An outstanding alternate bending fatigue strength of the rotor shaft 2 is thereby obtained.

FIG. 2 shows a diagrammatic view of a method for producing a turbine rotor 1 according to the invention.

FIG. 2a shows first the turbine wheel 3 with the axis of rotation 15, with the turbine wheel shoulder 5 and with the first end face 6. Furthermore, FIG. 2a shows the rotor shaft 2 with the axis of rotation 9, with the second end face 7 and with the depression 8.

The method steps of a possible method for producing a turbine rotor 1 according to the invention are described below:

First, the rotor shaft 2 and turbine wheel 3 are clamped coaxially into a rotary friction welding device. The rotary friction welding device is not illustrated in FIG. 2. The turbine wheel 3 is in this case preferably clamped fixedly in terms of its rotation. As shown in FIG. 2a, the rotor shaft 2 is set in rotation 12. Alternatively to this, the rotor shaft 2 may also be clamped fixedly in terms of rotation and the turbine wheel 3 set in rotation, or both joining partners are set in rotation.

As illustrated in FIG. 2b, the rotor shaft 2 set in rotation 12 is moved axially towards the turbine wheel 3 in the direction of the axis of rotation 9. In this case, the first end face 6 and the second end face 7 approach one another.

As soon as there is contact between the first end face 6 and second end face 7, as illustrated in FIG. 2c, the rotating 12 rotor shaft 2 is pressed with a defined force 14 onto the turbine wheel shoulder 5 of the turbine wheel 3. The magnitude of the force 14 and the circumferential speed of rotation 12 are essentially dependent on the material pairing of the joining partners to be welded together and on the diameters of the rotor shaft 2 or rotor shaft shoulder 18 and of the turbine wheel shoulder 5. As a result of pressing and rotation 12, frictional heat is produced, and the materials of the rotor shaft 2 and turbine wheel shoulder 5 pressed with their end faces 6, 7 one onto the other are welded to one another by rotary friction. By the rotating 12 rotor shaft 2 being pressed onto the stationary turbine wheel 3, however, material of the joining partners in the pasty state is also pressed away to the side, that is to say out of the region of the weld seam. The annular outer weld bead 10, which is generated thereby and is present on a surface area of the rotor shaft 2 and on a surface area of the turbine wheel shoulder 5, is subsequently removed. This removal of the weld bead 10 is not illustrated in FIG. 2. The weld bead 10 is preferably removed by means of a cutting method, in particular by means of a cylindrical grinding method with forming wheels. By using an appropriate forming wheel, the transition between the rotor shaft 2 and turbine wheel shoulder 5 can be brought quickly and cost-effectively into a desired final form. During cylindrical grinding, the rotor shaft shoulder 18 provided on the rotor shaft 2 can also be ground down to the desired diameter of the rotor shaft 2. Pasty material flowing in the direction of the axis of rotation 9 of the rotor shaft 2 is received by the cavity 8. There can therefore be no build-up of material in the region of the weld seam and consequently insufficient strength of the connection of the joining partners which has been made by rotary friction welding is avoided.

Although the present invention has been described fully by means of preferred exemplary embodiments, it is not restricted to these, but can be modified in various ways. In particular, features of the individual exemplary embodiments listed above may be combined with one another, as desired, insofar as this is technically expedient.

In a preferred modification of the present invention, the turbine blading is not formed as an integral part of the turbine wheel, but can be separated from this. It is thereby advantageously possible to exchange the turbine blading in the event of damage or to use a material for the turbine blading, such as, for example, a ceramic material, other than the basic material of the turbine wheel. The range of use of the turbine rotor according to the invention is thereby extended.

The materials, numerical particulars and dimensions listed are to be understood as being by way of example and serve merely for explaining the embodiments and developments of the present invention.

The turbine rotor specified and the turbocharger specified can be used especially advantageously in the motor vehicle sector and here preferably in passenger cars, for example in diesel or gasoline engines, but, if required, can also be used in any other turbocharger applications as desired.

1-8. (canceled)

9. A turbine rotor for a turbocharger, the turbine rotor comprising:
a turbine wheel formed in one piece, said turbine wheel having turbine blading and a turbine wheel shoulder with a first end face, said turbine blading and said turbine wheel shoulder being disposed on mutually opposite end faces of said turbine wheel;
said turbine wheel shoulder being formed as a solid structure, without cavities or depressions; and
a rotor shaft formed in one piece, said rotor shaft having a second end face and defining an axis of rotation;
said second end face of said rotor shaft having a depression formed therein coaxially with said axis of rotation;
said first end face of said turbine wheel shoulder being connected to said second end face of said rotor shaft in a materially integral connection formed by rotary friction welding, wherein said depression in said second end face of said rotor shaft receives plasticized material of said turbine wheel shoulder and/or of said rotor shaft.

10. The turbine rotor according to claim 9, wherein said turbine wheel shoulder is a projection that rises out of one of said end faces of said turbine wheel and that is rotationally symmetrical with respect to an axis of rotation of said turbine wheel.

11. The turbine rotor according to claim 9, wherein said rotor shaft is oriented coaxially to said turbine wheel shoulder.

12. The turbine rotor according to claim 9, wherein said rotor shaft is manufactured from an alloyed high-grade steel.

13. The turbine rotor according to claim 12, wherein said rotor shaft is formed of an alloyed high-grade steel with chromium, molybdenum, and vanadium as the main alloying components.

14. The turbine rotor according to claim 9, wherein said turbine wheel is manufactured from a nickel-based alloy.

15. The turbine rotor according to claim 9, wherein said turbine wheel is manufactured from a nickel-based alloy for high-temperature applications.

16. The turbine rotor according to claim 9, wherein said turbine wheel is a turbine wheel produced as a metal casting and having a cast-on part on said first end face.

17. The turbine rotor according to claim 9 configured for a turbocharger for a motor vehicle.

18. A turbocharger for a motor vehicle, comprising:
a turbine rotor according to claim 9;
a turbine casing housing said turbine wheel;
a compressor wheel disposed in a compressor casing; and
said rotor shaft connecting said turbine wheel to said compressor wheel in a rotationally fixed relationship.

19. A method of producing the turbine rotor, the method which comprises :
providing a turbine wheel with a solidly formed turbine wheel shoulder having a first end face formed without cavities or depressions, and coaxially clamping the turbine wheel into a rotary friction welding device;
providing a rotor shaft with a second end face having a depression formed therein coaxially to an axis of rotation, and coaxially clamping the rotor shaft into the rotary friction welding device;
rotating the rotor shaft;
pressing the second end face of the rotor shaft onto the first end face of the turbine wheel shoulder; and
rotary friction-welding the rotor shaft and the turbine wheel shoulder to one another with the respective end faces pressed with their end faces one onto the other.

20. The method according to claim 19 configured for producing thereby the turbine rotor according to claim 9.
